(19) United States
(12) Patent Application Publication
(10) Pub. No.: US 2023/0198567 A1
(43) Pub. Date: Jun. 22, 2023

(54) TRANSCEIVER MODIFICATION BASED ON DATA SIZES AND SIGNAL STRENGTHS

(71) Applicant: Hewlett-Packard Development Company, L.P., Spring, TX (US)

(72) Inventors: Chih-Hsin Lee, Taipei City (TW); Cheng-Chih Chen, Taipei City (TW); Haohsuan Ting, Taipei City (TW)

(21) Appl. No.: 17/552,863

(22) Filed: Dec. 16, 2021

(51) Int. Cl. H04B 1/44; H04B 17/318; H04W 24/08; G06F 1/20

(52) U.S. Cl. CPC H04B 1/44; H04B 17/318; H04W 24/08; G06F 1/203

(57) ABSTRACT

Example implementations relate to transceiver modification based on data sizes and signal strengths. In some examples, an electronic device can include a transceiver, the transceiver including a first transceiver circuit including a first transmitter and a first receiver and a second transceiver circuit including a second transmitter and a second receiver, and a processor, where the processor is to determine a data size of data to be transmitted to a host device, determine a signal strength of the first receiver and a signal strength of the second receiver with a host device, and modify the transceiver based on the data size and the signal strength of the first receiver and the signal strength of the second receiver.

### BACKGROUND

Electronic devices may be used to provide an altered reality to a user. Such electronic devices may include a mixed reality (MR) device. A MR device may include a virtual reality (VR) device and/or an augmented reality (AR) device. MR devices may include displays to provide a “virtual and/or augmented” reality experience to the user by providing video, images, and/or other visual stimuli to the user via the displays for work, education, gaming, multimedia, and/or other general use. MR devices may be worn by a user.

### BRIEF DESCRIPTION OF THE DRAWINGS

FIG. 1 illustrates an example of an electronic device and a host device for transceiver modification based on data sizes and signal strengths consistent with the disclosure.

FIG. 2 illustrates an example of an electronic device including a transceiver including transceiver circuits for transceiver modification based on data sizes and signal strengths consistent with the disclosure.

FIG. 3 illustrates an example of an electronic device including a transceiver including transceiver circuits for transceiver modification based on data sizes and signal strengths consistent with the disclosure.

FIG. 4 illustrates a block diagram of an example system for transceiver modification based on data sizes and signal strengths consistent with the disclosure.

### DETAILED DESCRIPTION

A user may utilize an electronic device such as an MR device for various purposes, such as for work, education, gaming, multimedia, and/or other general use. As used herein, the term “electronic device” refers to an electronic system having a processing resource, memory resource, and/or an application-specific integrated circuit (ASIC) that can process information.

Some MR devices are head mounted devices. As used herein, the term “MR device” refers to a device that provides a mixed reality to a user. As used herein, the term “mixed reality” refers to a computing device generated scenario that simulates experience through senses and perception. In some examples, an MR device covers a user's eyes and provides visual stimuli to the user via a display, thereby substituting a “mixed” reality (e.g., a “virtual reality” and/or “augmented reality”) for actual reality. In some examples, a MR device covers a user's ears and provides audible stimuli to the user via audio output devices to enhance or contribute to the virtual reality experienced by the user. In some examples, a MR device provides an overlay transparent or semi-transparent screen in front of a user's eyes such that reality is “augmented” with additional information such as graphical representations and/or supplemental data. For example, a MR device overlays transparent or semi-transparent weather information, directions, and/or other information on an MR display for a user to examine.

As a result of MR devices covering a user's eyes and/or ears, the user is immersed in the virtual reality created by a MR device. The immersive MR experience allows the user to experience a virtual reality with realistic images, sounds, and/or other sensations.

In order to provide a mixed reality experience to a user, an electronic device transmits and receives data from a host device that enables the electronic device to provide the mixed reality experience. Data received by the electronic device from the host device can include audio, video, and/or haptic data, and data transmitted by the electronic device to the host can include gesture information of the electronic device, camera positioning information of the electronic device, and/or other sensor and/or control data from the electronic device. In order for the electronic device to provide a fluid MR experience, the electronic device typically transmits and receives data from the host device via a wireless connection. This can ensure a user does not come into contact with any wires that would otherwise connect the electronic device with the host device when such devices are connected via a wired connection.

Data received by the electronic device from the host device is typically larger than data transmitted by the electronic device to the host device. As used herein, the term “host device” refers to a computing device to wirelessly communicate with an electronic device. For example, data received by the electronic device from the host device can include high quality video stream data, whereas data transmitted by the electronic device to the host device can include sensor and/or control data that is of a smaller size than data received by the electronic device from the host device.

Transceiver modification based on data sizes and signal strengths can allow for modification of a transceiver of an electronic device based on a data size of data to be transmitted to the host device and a signal strength of receivers of the transceiver with the host device. Based on a data size of data to be transmitted to the host device, a subset of transmitters of the electronic device can be deactivated. Such an approach can provide for decreased energy consumption by the electronic device allowing for an increase in battery life of the electronic device as well as better thermal dissipation for electronic circuits associated with the electronic device as compared with previous approaches.

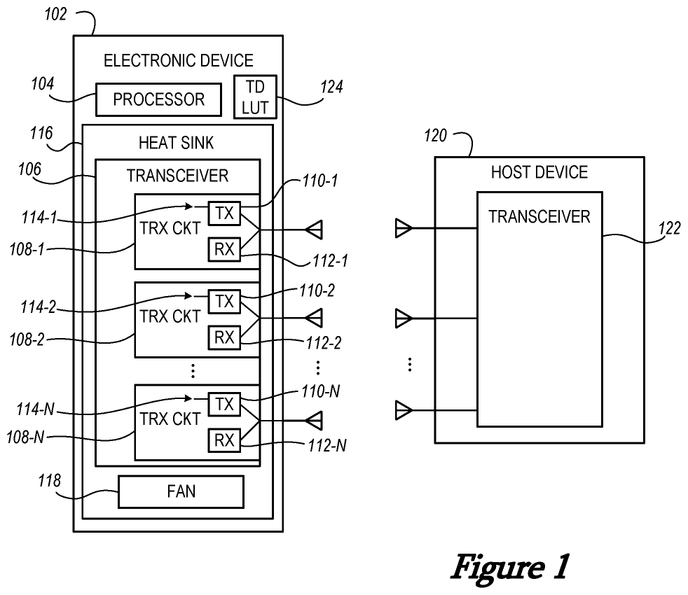

FIG. 1 illustrates an example of an electronic device 102 and a host device 120 for transceiver modification based on data sizes and signal strengths consistent with the disclosure. As illustrated in FIG. 1, the electronic device 102 can include a processor 104 and a transceiver 106. The host device 120 can include a transceiver 122.

As mentioned above, the electronic device 102 can be an MR device that can provide an MR experience for a user. The electronic device 102 provides the MR experience by receiving data from the host device 120. Such data includes video, audio, and/or haptic data that is utilized to provide the MR experience for a user utilizing the electronic device 102. Additionally, the electronic device 102 transmits information back to the host device 120. Such information transmitted to the host device 120 includes gesture information of the electronic device 102, camera positioning information of the electronic device 102, and/or other sensor and/or control data from the electronic device 102. While the electronic device 102 transmits such data to the host device 120, it is typically smaller than the data received from the host device 120. Accordingly, the electronic device 102 can deactivate a subset of transmitters 110-1, 110-2, 110-N such that the electronic device 102 draws less current and/or has improved thermal dissipation, as is further described herein.

As illustrated in FIG. 1, the electronic device 102 includes a transceiver 106. As used herein, the term “transceiver” refers to an electronic device that includes a transmitter and a receiver. The transceiver 106 is capable of transmitting information (e.g., packets) and receiving information (e.g., packets). As used herein, the term “packet” refers to a formatted unit of data. For example, the transceiver 106 transmits packets to and receives packets from the host device 120, as is further described herein.

The transceiver 106 can be a Wi-Fi transceiver. For example, the transceiver 106 transmits information to the host device 120 and receives information from the host device 120 over a Wi-Fi network relationship.

Although the electronic device 102 and the host device 120 are described above as communicating via a Wi-Fi network relationship, examples of the disclosure are not so limited. For example, the electronic device 102 and the host device 120 can be connected via other wireless network relationships. Examples of such a network relationship can include a wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

The transceiver 106 includes transceiver circuits 108-1, 108-2, 108-N. As used herein, the term “transceiver circuit” refers to a network of electrical devices arranged to transmit and/or receive information from another device. The transceiver circuit 108-1 includes, for example, a transmitter 110-1 and a receiver 112-1. As used herein, the term “transmitter” refers to an electrical device that generates and transmits electromagnetic waves. As used herein, the term “receiver” refers to an electrical device that receives electromagnetic waves and/or converts them into usable form. For example, the transmitter 110-1 of the transceiver circuit 108-1 transmits packets (e.g., data) to the transceiver 122 of the host device 120 via a Wi-Fi connection therebetween and the receiver 112-1 of the transceiver circuit 108-1 receives packets (e.g., information) from the transceiver 122 of the host device 120 via the Wi-Fi connection therebetween. Similarly, the transceiver circuit 108-2 includes a transmitter 110-2 and a receiver 112-2 and the transceiver circuit 108-N includes a transmitter 110-N and receiver 112-N to transmit packets to and receive packets from the host device 120.

The transmitters 110-1, 110-2, 110-N include power amplifiers. As used herein, the term “power amplifier” refers to an electronic device that increases a magnitude of an electronic input signal. For example, the transmitters 110-1, 110-2, 110-N receive an input signal and increase the magnitude (e.g., the amplitude) of the signal to generate an output signal. The output signal is transmitted by the transmitters 110-1, 110-2, 110-N to be received by the transceiver 122 of the host device 120.

The receivers 112-1, 112-2, 112-N include low-noise amplifiers. As used herein, the term “low-noise amplifier” refers to an electronic device that amplifies a very low-power signal while minimizing signal noise. For example, the receivers 112-1, 112-2, 112-N receive a low-power signal (e.g., data) transmitted from the host device 120 and amplify the signal for use by the electronic device 102.

Similarly, the host device 120 includes a transceiver 122. The transceiver 122 can similarly by a Wi-Fi transceiver that communicates with the transceiver 106 of the electronic device 102. The transceiver 122 is a symmetric transmission and reception multiple-input and multiple-output (MIMO) transceiver.

In order for the electronic device 102 to determine whether to deactivate a subset of transmitters 110-1, 110-2, 110-N, the processor 104 determines a data size of data to be transmitted to the host device 120. For example, the during operation of the electronic device 102, data is to be transmitted from the electronic device 102 to the host device 120. The data can be, for example, sensor data from sensors included in the electronic device 102 (e.g., not illustrated in FIG. 1). The processor 104 can determine the data size of the data to be 450 megabytes (MB).

Based on the data size of the data, the processor 104 determines an amount of transmitters 110-1, 110-2, 110-N to transmit the data to the host device 120. In order to make such a determination, the processor 104 compares the data size (e.g., 450 MB) to a transmission data lookup table 124. As used herein, the term “lookup table” refers to a data structure to organize information in which an input value results in an output value. For example, the transmission data lookup table 124 can include data ranges and an amount of transmitters associated with the data ranges. For instance, the transmission data lookup table 124 can be a table such as Table 1 below:

TABLE 1

| Data Range | Transmitters |
|---|---|
| 0-350 MB | 1 |
| 350-700 MB | 2 |
| 700-1,050 MB | 3 |

As illustrated in Table 1 above, the transmission data lookup table 124 can include various data ranges with corresponding transmitter amounts. Continuing with the example from above, the processor 104 compares the data size to the transmission data lookup table 124 to determine that two transmitters of the transmitters 110-1, 110-2, 110-N should be utilized to transmit the data to the host device 120.

Although the transmission data lookup table 124 is illustrated above in Table 1 as including three data ranges, examples of the disclosure are not so limited. For example, the data ranges can be dictated by an amount of transmitters 110-1, 110-2, 110-N include in the transceiver 106. The data ranges may be described as 350*(N−1) MB, where N is the total amount of transmitters included in the transceiver 106. For example, if the transceiver 106 includes six transmitters, the data ranges may reach as high as 1,750 MB (e.g., in multiples of 350 MB).

To determine which of the transmitters 110-1, 110-2, 110-N should be utilized to transmit the data to the host device 120, the processor 102 determines the signal strength of the receivers 112-1, 112-2, 112-N. As used herein, the term “signal strength” refers to a transmitter power output as received by a reference antenna located a distance from the transmitting antenna. In some examples, the signal strength is a received signal strength indicator (RSSI) value. For example, the processor 104 determines the signal strength (e.g., as RSSI values) with the host device 120 of the receiver 112-1 to be −50 decibel-milliwatts (dBm), the signal strength of the receiver 112-2 to be −65 dBm, and the signal strength of the receiver 112-N to be −63 dBm. The processor 104 is to modify the transceiver 106 based on the data size and the signal strengths of the receivers 112-1, 112-2, 112-N, as is further described herein.

Once the processor 104 has determined the signal strengths of the receivers 112-1, 112-2, 112-N, the processor 104 sorts the receivers 112-1, 112-2, 112-N by signal strength. The processor 104 can sort the receivers from highest signal strength to lowest signal strength via a sorting mechanism. As used herein, the term “sorting mechanism” refers to computer readable instructions that take elements from a list and put the elements into an order. For example, the processor 104 sorts the receivers in order of highest to lowest signal strength, where the order is receiver 112-1, receiver 112-N, and receiver 112-2, where receiver 112-1 has the highest signal strength, receiver 112-N has the second highest signal strength, and receiver 112-2 has the lowest signal strength of the receivers 112-1, 112-2, 112-N. The processor 104 may utilize any sorting mechanism, such as comparison sorting mechanisms, non-comparison sorting mechanisms, or any other type of sorting mechanism.

As the processor 104 determined the data size of the data (e.g., 450 MB) should utilize two transmitters 110-1, 110-2, 110-N, the processor 104 can modify the transceiver 106 to deactivate a subset of transmitters 110-1, 110-2, 110-N based on the sorted receivers 112-1, 112-2, 112-N (e.g., sorted by signal strength). For example, the processor 104 determines transmitters 110-1 and 110-N should be utilized to transmit the data to the host device 120 based on the receivers 112-1, 112-N having the highest signal strengths. That is, the processor 104 can determine transmitter(s) to transmit the data to the host device 120 in response to the receiver(s) corresponding to the transmitter(s) having the highest signal strength.

Accordingly, the processor 104 modifies the transceiver 106 based on the data size indicating two transmitters of the transmitters 110-1, 110-2, 110-N to transmit the data to the host device 120 and the two receivers corresponding to the two transmitters having the highest signal strengths of the receivers 112-1, 112-2, 112-N. Accordingly, the processor 104 modifies the transceiver 106 by deactivating the transmitter 110-2.

The processor 104 deactivates the transmitter 110-2 by transmitting a disable signal to a pin 114-2 associated with the transmitter 110-2. As used herein, the term “pin” refers to an electronic device in a circuit that is activated or deactivated. For instance, the processor 104 transmits a disable signal to pin 114-2 which can cause the pin 114-2 to be a particular voltage. The particular voltage can cause the pin to be disabled. For instance, the disable signal can cause pin 114-2 to be switched from an active-high voltage (e.g., 3.3 volts (V) or 5 V) to a low voltage (e.g., 0 V) or from an active-low voltage (e.g., 0V) to a high voltage (e.g., 3.3V or 5V). Accordingly, when the pin 114-2 receives the disable signal, the transmitter 110-2 is disabled such that it no longer generates and transmits electromagnetic waves.

The processor 104 then transmits the data to the host device 120 via the modified transceiver 106. For example, the transmitter 110-1 and transmitter 110-N transmit packets comprising the data to the host device 120 since the transmitter 110-2 is deactivated.

Although the processor 104 is described above as modifying the transceiver by deactivating the transmitter 110-2 and transmitting the data using two transmitters 110-1, 110-N, examples of the disclosure are not so limited. For example, in an instance where the data size is determined to be less than 350 MB (e.g., 200 MB), the processor 104 compares the data size to the transmission data lookup table 124 and determines that one transmitter of the transmitters 110-1, 110-2, 110-N should be utilized to transmit the data to the host device 120. The processor 104 sorts the receivers 112-1, 112-2, 112-N by signal strength and determines that since receiver 112-1 has the highest signal strength (e.g., the signal strength of receiver 112-1 is greater than the signal strength of receivers 112-2, 112-N), transmitter 110-1 (e.g., corresponding to the receiver 112-1) should be utilized to transmit the data to the host device 120. The processor 104 modifies the transceiver 106 by deactivating the transmitters 110-2, 110-N. Accordingly, the transmitter 110-1 can transmit packets comprising the data to the host device 120 since transmitters 110-2, 110-N are deactivated.

Accordingly, as the processor 104 deactivates a subset of transmitters 110-1, 110-2, 110-N, the electronic device 102 draws less current. Such an approach can accordingly lead to a longer battery life for the electronic device. Additionally, deactivating a subset of transmitters 110-1, 110-2, 110-N can allow for increased thermal dissipation as compared with previous approaches as is further described herein.

The processor 104 determines a temperature of the heat sink 116 of the electronic device 102 in response to deactivating transmitter 110-2. As used herein, the term “heat sink” refers to a heat exchanger that transfers heat generated by an electronic device to another medium. For example, the heat sink 116 can transfer heat generated by the transceiver 106 to ambient air surrounding the electronic device 102.

The processor 104 may determine the temperature of the heat sink 116 after a particular amount of time following deactivating the transmitter 110-2. For example, the processor 104 may wait five seconds and then determine the temperature of the heat sink 116.

The processor 104 determines the temperature of the heat sink 116 via a thermal sensor (e.g., not illustrated in FIG. 1). The thermal sensor can be, for example, a thermistor, among other types of thermal sensors.

As an example, the processor 104 determines the temperature of the heat sink 116 to be 40 degrees Celsius (° C.). The processor 104 controls the fan 118 associated with the heat sink 116 based on the temperature of the heat sink 116. As used herein, the term “fan” refers to a hardware device that circulates air across a heat sink to aid in heat transfer. For example, in response to the temperature of the heat sink 116 being below a threshold temperature (e.g., 60° C.), the processor 104 controls the rotations per minute (RPM) of the fan 118, as is further described herein.

In some examples, the processor 104 controls the fan 118 by reducing the speed of the fan from a first RPM to a second RPM. For instance, the processor 104 reduces the speed of the fan 118 from 3,000 RPM to 2,000 RPM. The reduction in RPM can be done since transmitters 110-2 and 110-N are disabled, and as a result, generate less heat.

In some examples, the processor 104 controls the fan 118 by deactivating the fan 118. For example, the processor 104 reduces the speed of the fan 118 from 3,000 RPM to 0 RPM.

As such, transceiver modification based on data sizes and signal strengths can allow for modification of a transceiver of an electronic device based on a data size of data to be transmitted to a host device and a signal strength of receivers of the transceiver. Such an approach can provide for decreased energy consumption by the electronic device allowing for an increase in battery life of the electronic device as well as better thermal dissipation for electronic circuits associated with the electronic device as compared with previous approaches.

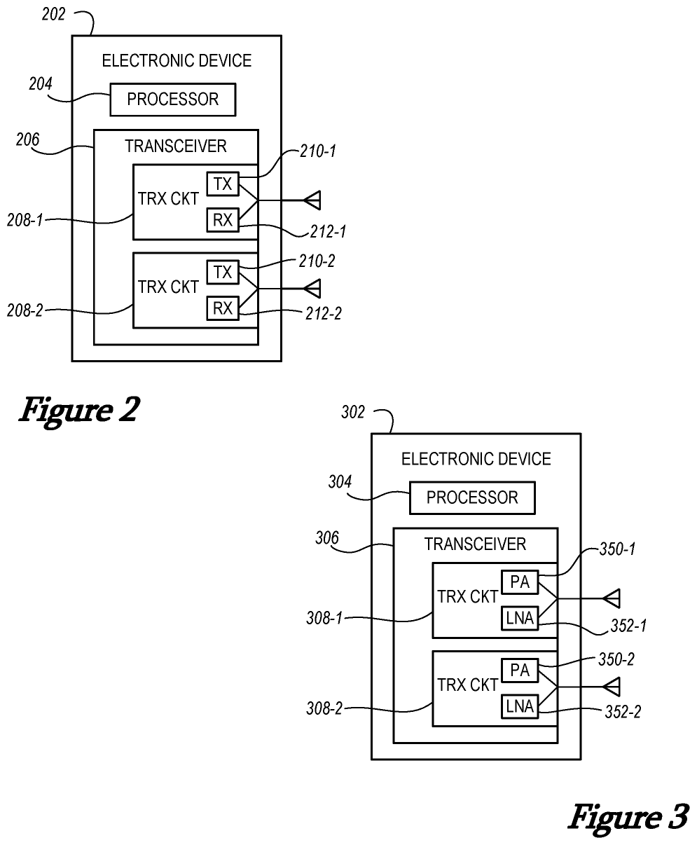

FIG. 2 illustrates an example of an electronic device 202 including a transceiver 206 including transceiver circuits 208 for transceiver modification based on data sizes and signal strengths consistent with the disclosure. As illustrated in FIG. 2, the electronic device 202 can include a processor 204 and a transceiver 206.

The transceiver 206 of the electronic device 202 can include a first transceiver circuit 208-1 and a second transceiver circuit 208-2. The first transceiver circuit 208-1 can include a first transmitter 210-1 and a first receiver 212-1. The second transceiver circuit 208-2 can include a second transmitter 210-2 and a second receiver 212-2.

As previously described in connection with FIG. 1, the processor 204 determines a data size of data to be transmitted to a host device. Additionally, the processor 204 determines a signal strength of the first receiver 212-1 and a signal strength of the second receiver 212-2 with the host device.

The processor 204 modifies the transceiver 206 based on the data size and the signal strength of the first receiver 212-1 and the second receiver 212-2. For example, based on the data size, the processor 204 determines an amount of transmitters to transmit the data, and based on a sorted list of the signal strengths of the first receiver 212-1 and the second receiver 212-2, the processor 204 deactivates the second transmitter 210-2. Accordingly, the first transmitter 210-1 transmits data to the host device.

FIG. 3 illustrates an example of an electronic device 302 including a transceiver 306 including transceiver circuits 308 for transceiver modification based on data sizes and signal strengths consistent with the disclosure. As illustrated in FIG. 3, the electronic device 302 can include a processor 304 and a transceiver 306.

The transceiver 306 of the electronic device 302 includes a first transceiver circuit 308-1. The first transceiver circuit 308-1 includes a first power amplifier 350-1 (e.g., analogous to the first transmitter 110-1, 210-1, previously described in connection with FIGS. 1 and 2, respectively) to transmit packets to a host device and a first low-noise amplifier 352-1 (e.g., analogous to the first receiver 112-1, 212-1, previously described in connection with FIGS. 1 and 2, respectively) to receive packets from the host device.

Additionally, the transceiver 306 of the electronic device 302 includes a second transceiver circuit 308-2. The second transceiver circuit 308-2 includes a second power amplifier 350-2 (e.g., analogous to the second transmitter 110-2, 210-2, previously described in connection with FIGS. 1 and 2, respectively) to transmit packets to the host device and a second low-noise amplifier 352-2 (e.g., analogous to the second receiver 112-2, 212-2, previously described in connection with FIGS. 1 and 2, respectively) to receive packets from the host device.

As previously described in connection with FIG. 1, the processor 304 is to determine a data size of data to be transmitted to the host device. For example, the processor 304 is to determine the data size of the data to be transmitted to the host device is 120 MB.

The processor 304 determines, based on the data size, an amount of power amplifiers to transmit the data. For example, the processor 304 compares the data size to a transmission data lookup table to determine one transmitter should be utilized to transmit the data.

The processor 304 is to determine a signal strength of the first low-noise amplifier 352-1 and a signal strength of the second low-noise amplifier 352-2 with the host device. For example, the processor 304 determines the signal strength with the host device of the first low-noise amplifier 352-1 to be −50 dBm and the signal strength with the host device of the second low-noise amplifier 352-2 to be −65 dBm.

In response to the signal strength of the first low-noise amplifier 352-1 being greater than the signal strength of the second low-noise amplifier 352-2 and based the determined amount of power amplifiers, the processor 304 deactivates the second power amplifier 350-2. Accordingly, the processor 304 is to communicate with the host device via the first power amplifier 350-1, the first low-noise amplifier 352-1, and the second low-noise amplifier 352-2. For example, the processor 304 causes the first power amplifier 350-1 to transmit packets comprising the data to the host device. Additionally, the first low-noise amplifier 352-1 and the second low-noise amplifier 352-2 can receive packets from the host device.

In some examples, the processor 304 may determine, based on the data size, that two power amplifiers should be utilized to transmit the data. For example, the processor 304 may determine the data size is 375 MB. Accordingly, the processor 304 causes the first power amplifier 350-1 and the second power amplifier 350-2 to transmit the packets comprising the data to the host device.

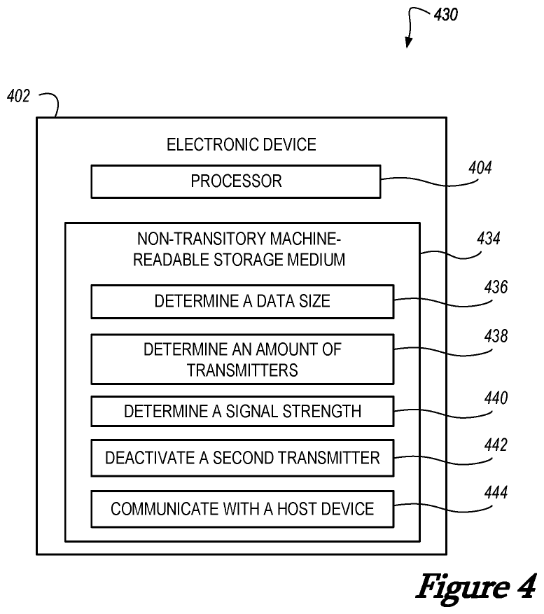

FIG. 4 illustrates a block diagram of an example system 430 for transceiver modification based on data sizes and signal strengths consistent with the disclosure. In the example of FIG. 4, system 430 includes a processor 404 and a non-transitory machine-readable storage medium 434. The processor 404 can be a processing resource. The following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

The processor 404 may be a central processing unit (CPU), microprocessor, and/or other hardware device suitable for retrieval and execution of instructions stored in a non-transitory machine-readable storage medium 434. In the particular example shown in FIG. 4, the processor 404 may receive, determine, and send instructions 436, 438, 440, 442, 444. As an alternative or in addition to retrieving and executing instructions, the processor 404 may include an electronic circuit comprising a number of electronic components for performing the operations of the instructions in the non-transitory machine-readable storage medium 434. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 434 may be any electronic, magnetic, optical, or other physical storage device that stores executable instructions. Thus, the non-transitory machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. The non-transitory machine-readable storage medium 434 may be a portable, external or remote storage medium, for example, that allows the system 430 to download the instructions from the portable/external/remote storage medium. In this situation, the executable instructions may be part of an “installation package”.

Determine instructions 436, when executed by the processor 404, may cause system 430 to determine a data size of data to be transmitted to a host device. For example, the processor 404 can determine the data size of the data to be transmitted to the host device to be 120 MB.

Determine instructions 438, when executed by the processor 404, may cause system 430 to determine, based on the data size, an amount of transmitters to transmit the data. For example, the processor 404 compares the data size to a transmission data lookup table to determine an amount of transmitters to be utilized to transmit the data (e.g., one transmitter).

Determine instructions 440, when executed by the processor 404, may cause system 430 to determine a signal strength of a first receiver of a first transceiver circuit and a signal strength of a second receiver of a second transceiver circuit with the host device. For example, the processor 404 determines the signal strength with the host device of the first receiver to be −50 dBm and the signal strength with the host device of the second receiver to be −65 dBm. The processor 404 is to sort the signal strengths of the receivers from highest to lowest.

Deactivate instructions 442, when executed by the processor 404, may cause system 430 to deactivate a second transmitter of the second transceiver circuit. For example, the processor 402 determines the signal strength of the first receiver is higher than the signal strength of the second receiver. In response, the processor 402 deactivates a second transmitter of the second transceiver circuit.

Communicate instructions 444, when executed by the processor 404, may cause system 430 to communicate with the host device by receiving packets from the host device via the first receiver and the second receiver and transmitting packets comprising the data to the host device via the first transceiver circuit. That is, the processor 402 communicates with the host device by transmitting packets comprising the data to the host device via the first transmitter while the second transmitter is deactivated.

In the foregoing detailed description of the disclosure, reference is made to the accompanying drawings that form a part hereof, and in which is shown by way of illustration how examples of the disclosure may be practiced. These examples are described in detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed is:

1. An electronic device, comprising:
a transceiver, the transceiver including:
a first transceiver circuit including a first transmitter and a first receiver; and
a second transceiver circuit including a second transmitter and a second receiver; and
a processor, wherein the processor is to:
determine a data size of data to be transmitted to a host device;
determine a signal strength of the first receiver and a signal strength of the second receiver with a host device; and
modify the transceiver based on the data size and the signal strength of the first receiver and the signal strength of the second receiver.

2. The electronic device of claim 1, wherein the processor is to transmit the data to the host device via the modified transceiver.

3. The electronic device of claim 1, wherein the processor is to determine, based on the data size, an amount of transmitters to transmit the data.

4. The electronic device of claim 1, wherein modifying the transceiver includes deactivating the second transmitter in response to the signal strength of the first receiver being greater than the signal strength of the second receiver.

5. The electronic device of claim 1, wherein the first receiver and the second receiver are to receive packets from the host device.

6. The electronic device of claim 4, wherein the first transmitter is to transmit packets comprising the data to the host device in response to the second transmitter being deactivated.

7. The electronic device of claim 1, wherein the transceiver is a Wi-Fi transceiver.

8. The electronic device of claim 1, wherein the signal strengths of the first receiver and the second receiver are received signal strength indicator (RSSI) values.

9. The electronic device of claim 1, wherein the first transmitter and the second transmitter are power amplifiers.

10. The electronic device of claim 1, wherein the first receiver and the second receiver are low-noise amplifiers.

11. A non-transitory machine-readable storage medium including instructions that when executed cause a processor of an electronic device to:
determine a data size of data to be transmitted to a host device;
determine, based on the data size, an amount of transmitters to transmit the data;
determine a signal strength of a first receiver of a first transceiver circuit and a signal strength of a second receiver of a second transceiver circuit with the host device;
deactivate a second transmitter of the second transceiver circuit based on the signal strengths of the first receiver and the second receiver and the amount of transmitters to transmit the data; and
communicate with the host device by:
receiving packets from the host device via the first receiver and the second receiver; and
transmitting packets comprising the data to the host device via the first transceiver circuit.

12. The non-transitory storage medium of claim 11, including instructions to determine the amount of transmitters by comparing the data size with a transmission data lookup table.

13. The non-transitory storage medium of claim 11, including instructions to transmit the packets comprising the data to the host device via a first transmitter of the first transceiver circuit.

14. The non-transitory storage medium of claim 11, including instructions to:
determine a temperature of a heat sink of the electronic device in response to deactivating the second transmitter; and
control a fan associated with the heat sink based on the temperature of the heat sink.

15. The non-transitory storage medium of claim 14, including instructions to control the fan by reducing a speed of the fan from a first rotation per minute (RPM) to a second RPM.

16. The non-transitory storage medium of claim 14, including instructions to determine the temperature of the heat sink after a particular amount of time following deactivating the second transmitter.

17. An electronic device, comprising
a transceiver, the transceiver including:
a first transceiver circuit including:
a first power amplifier to transmit packets to a host device; and
a first low-noise amplifier to receive packets from the host device; and
a second transceiver circuit including:
a second power amplifier to transmit packets to the host device; and
a second low-noise amplifier to receive packets from the host device;
a processor, wherein the processor is to:
determine a data size of data to be transmitted to the host device;
determine, based on the data size, an amount of power amplifiers to transmit the data;
determine a signal strength of the first low-noise amplifier and a signal strength of the second low-noise amplifier with a host device;
in response to the signal strength of the first low-noise amplifier being greater than the signal strength of the second low-noise amplifier and based on the amount of power amplifiers, deactivate the second power amplifier; and
communicate with the host device via the first power amplifier, the first low-noise amplifier, and the second low-noise amplifier.

18. The electronic device of claim 17, wherein the processor is to cause, based on the amount of power amplifiers to transmit the data, the first power amplifier to transmit packets comprising the data to the host device.

19. The electronic device of claim 17, wherein the processor is to deactivate the second power amplifier by transmitting a disable signal to a pin associated with the second power amplifier.

20. The electronic device of claim 17, wherein the processor is to cause based on the amount of power amplifiers to transmit the data, the first power amplifier and the second power amplifier to transmit packets comprising the data to the host device.
